(19) United States
(12) Patent Application Publication
(10) Pub. No.: US 2004/0088972 A1
(43) Pub. Date: May 13, 2004

(54) Hydraulic control arrangement

(76) Inventors: Edwin Harnischfeger, Jossgrund (DE); Manfred Mager, Neuss (DE)

Correspondence Address: Jay G Durst, Boyle Fredrickson Newholm Stein & Gratz, 250 Plaza Suite 1030, 250 East Wisconsin Avenue, Milwaukee, WI, 53202, US

(21) Appl. No.: 10/276,044

(22) PCT Filed: Apr. 3, 2001
(86) PCT No.: PCT/DE01/01255

(30) Foreign Application Priority Data
May 11, 2000 (DE) 10022910.7
Jun. 27, 2000 (DE) 10030327.7

(51) Int. Cl. F16D 31/02

(52) U.S. Cl. 60/469

(57) ABSTRACT

What is disclosed is a hydraulic control arrangement for attenuating travel vibrations of a mobile working tool, comprising a lift cylinder supporting a working tool, the cylinder chambers of which may be connected to a pressure medium source or to a tank via a control valve arrangement. The hydraulic control arrangement moreover includes an attenuation valve arrangement for connection of one cylinder chamber with an hydraulic accumulator and of the other cylinder chambers with a tank. In accordance with the invention, the attenuation valve arrangement includes a valve having a pressure limiting function and arranged between a check valve and the hydraulic accumulator, so that the pressure in the hydraulic accumulator may reliably be limited to a maximum value.

The invention relates to a hydraulic control arrangement in accordance with the preamble of claim 1.

The like control arrangements are used, for example, as stabilization modules in wheel loaders in order to attenuate the pitching vibrations occurring in travel. From DE 197 54 828 C2 to the same applicant, a stabilization module for wheel loaders is known, wherein a boom is supported by hydraulic cylinders. During travel, the cylinder chambers of the hydraulic cylinders acting in the supporting direction are connected to a hydraulic accumulator. The rod-side ring chambers of the hydraulic cylinders are connected to the tank via another logic valve. Between the cylinder chambers and the hydraulic accumulator a valve assembly including a logic valve is arranged which blocks the connection between the hydraulic accumulator and the hydraulic cylinders in its closed position. An end face of a valve body of the logic valve acting in the closing direction may be relieved via an electrically actuated directional control valve, so that the logic valve may be taken into its open position by the pressure in the hydraulic accumulator and in the cylinder chambers of the hydraulic cylinders acting in the opening direction.

Securing the hydraulic accumulator against excessive pressure rises in the hydraulic cylinders is effected through the intermediary of another directional control valve which may be set by the pressure in the hydraulic accumulator into a switching position wherein the pressure in the hydraulic accumulator may be applied to the end face of the valve body that acts in the closing direction, so that the logic valve is returned into its blocking position, and the hydraulic accumulator is protected against overload. In this mode, the electrically actuated directional control valve is returned to its home position against the force of the electromagnet by means of a pilot valve.

It is a drawback in this solution that for securing the hydraulic accumulator, considerable expense in terms of device technology is required, with an electrically operated directional control valve piloted through a pilot valve, another directional control valve for securing, and two logic valves associated with the cylinder chambers and the ring chambers of the hydraulic cylinders, respectively. It is moreover problematic that the response characteristics of this known stabilization mode, in particular the response characteristics of the pilot valve arranged upstream from the electrically operated directional control valve, is too slow for preventing overload of the hydraulic accumulator. It is another drawback of this known solution that the logic valve associated with the ring chambers of the hydraulic cylinders is closed upon retraction of the hydraulic cylinder, so that cavitation phenomena may occur due to the negative pressure in the ring chamber.

In DE 39 09 205 C1, a hydraulic control arrangement is shown wherein in the traveling condition of a machine the cylinder chambers of the hydraulic cylinders are connected with an hydraulic accumulator via an electrically operated directional control valve, and the rod-side ring chambers of the hydraulic cylinders with the tank. In order to limit the pressure in the hydraulic accumulator, a pressure reducing valve is arranged between these and the hydraulic cylinders, whereby the pressure in the hydraulic accumulator may be limited to a maximum value. Between pressure reducing valve and hydraulic accumulator a check valve is provided, whereby a reduction of the hydraulic accumulator load via the pressure reducing valve is prevented. This pressure reducing valve is arranged in a filling line leading to the hydraulic accumulator, to which filling line other consumers are also connected. At unfavorable operating conditions it may happen that these other consumers produce pressure peaks that are passed on into the hydraulic accumulator due to a sluggish reaction of the pressure reducing valve. Reducing these pressure peaks is not possible, so in this construction, as well, damage to the hydraulic accumulator is not excluded.

In contrast, the invention is based on the objective of providing a hydraulic control arrangement for attenuating travel vibrations of mobile working tools, whereby damage to a hydraulic accumulator may be prevented at minimum expense in terms of device technology.

This objective is attained through a hydraulic control arrangement having the features of claim 1.

In accordance with the invention, in a line section between the hydraulic cylinders and the hydraulic accumulator a pressure limiting valve is arranged, where a check valve is arranged upstream from the pressure limiting valve when viewed in the direction of flow from the hydraulic cylinder to the hydraulic accumulator. Owing to this relative arrangement, the pressure in the hydraulic accumulators may be limited to a predetermined maximum value through the intermediary of the pressure limiting valve, wherein it is possible to relieve the hydraulic accumulator load toward the tank with the aid of the check valve arranged upstream from the pressure limiting valve.

In this way, even in the event of pressure peaks reaching the hydraulic accumulator due to a sluggish reaction of the attenuation valve arrangement, these pressure peaks may be reduced with maximum rapidity, so that the operational safety of the hydraulic control arrangement is improved substantially in comparison with the conventional solutions. Another advantage of the solution according to the invention resides in the fact that in contrast with the construction described above, the expense in terms of device technology is lower at a superior function.

The check valve of the invention is preferably designed to be releasable, wherein the control pressure for releasing is preferably tapped at the hydraulic cylinder or at the hydraulic accumulator. Tapping at the hydraulic accumulator has the advantage that the transformation ratio of the releasable check valve may be selected to be lower on account of the higher pressure level.

The attenuation valve arrangement of the invention is advantageously designed with a directional control valve whereby in the traveling condition it is, e.g., possible to connect the rod-side ring chamber to a tank und/oder the control port of the check valve to the one cylinder chamber (on the bottom side of the lift cylinder) or to the hydraulic accumulator.

Connection of the ring chamber of the hydraulic cylinder with the tank may alternatively also be effected through an actuator valve or through another releasable check valve. In the latter case, the control port of the another releasable check valve is subjected to the same pressure as the former check valve.

In an advantageous development of the invention due to the actuator valve, on the one hand the ring chamber of the hydraulic cylinders is connected to the tank connected, and on the other hand the releasable check valve is also released through mechanical or hydraulic coupling, so that the pressure accumulator is connected with the one cylinder chamber of the hydraulic cylinder such means are characterized by a particularly simple structure. Here it is moreover advantageous if a piston of the actuator valve additionally acts as a topping piston for the check valve, so that in comparison with conventional solutions a separate topping piston for the releasable check valve may be omitted.

Operational safety of the hydraulic circuit is increased due to the fact that deactivating means are associated to the directional control valve, whereby the latter is switched back into its inoperative position in the event of pressure peaks, so that the attenuation arrangement may be overruled, as it were, and damage to the hydraulic accumulator may be prevented.

In accordance with the invention, the attenuation valve arrangement is realized by a pressure control valve having a tank port, a pressure port connected with the pressure accumulator, and an inlet port connected with the cylinder chamber. The valve element of the pressure control valve is acted on by the pressure in the hydraulic accumulator on the one hand and by the force of a compression spring and the pressure in the first cylinder chamber on the other hand. When a pressure peak builds up in the hydraulic accumulator, the valve element may be taken into a pressure limiting position wherein the pressure in the hydraulic accumulator may be limited to a maximum value.

In order to relieve the hydraulic accumulator, the pressure valve arrangement may be bypassed with the aid of a bypass line having a manually operated shut-off valve arranged therein. By opening this shut-off valve, the hydraulic accumulator may be relieved towards the tank.

The pressure control valve of the invention has a particularly compact design if a measuring piston is assigned to the piston element, which measuring piston is supported on the housing, guided in the piston element, and capable of being subjected to the pressure in the hydraulic accumulator on the end face side.

Other advantageous developments of the invention are subject matters of the further subclaims.

In the following, preferred embodiments of the invention are explained in more detail by referring to schematic drawings, wherein:

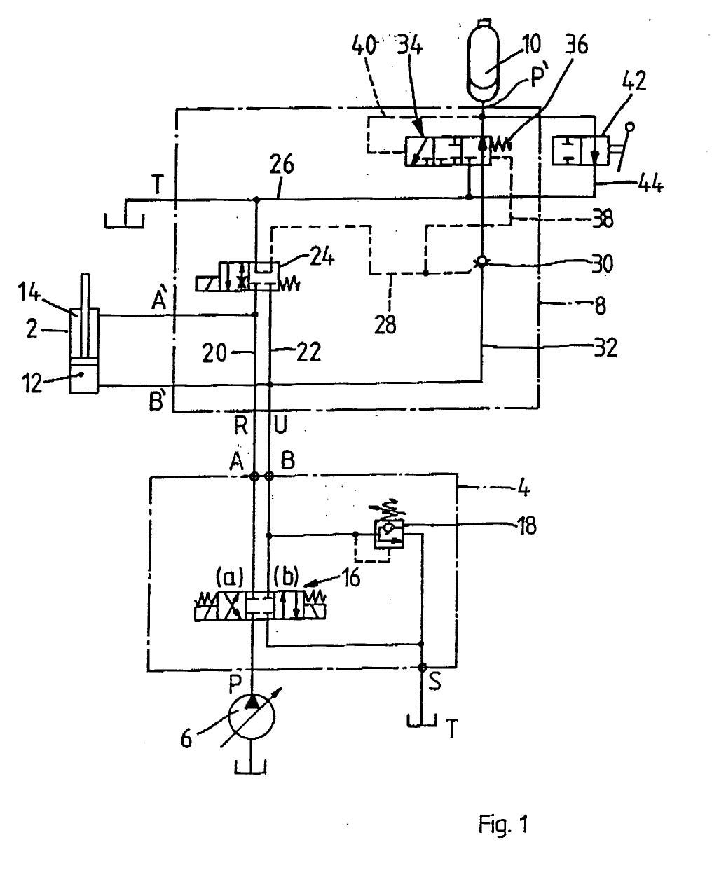

FIG. 1 is a switching diagram of a first embodiment of a control arrangement in accordance with the invention;

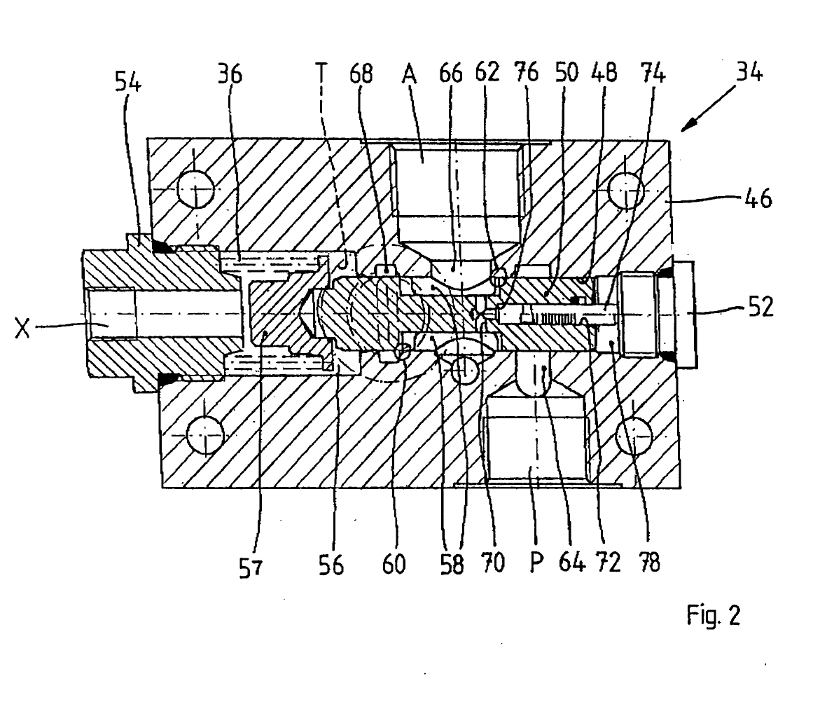

FIG. 2 is sectional view of an embodiment of a pressure limiting/pressure reducing valve of the attenuation valve arrangement of FIG. 1;

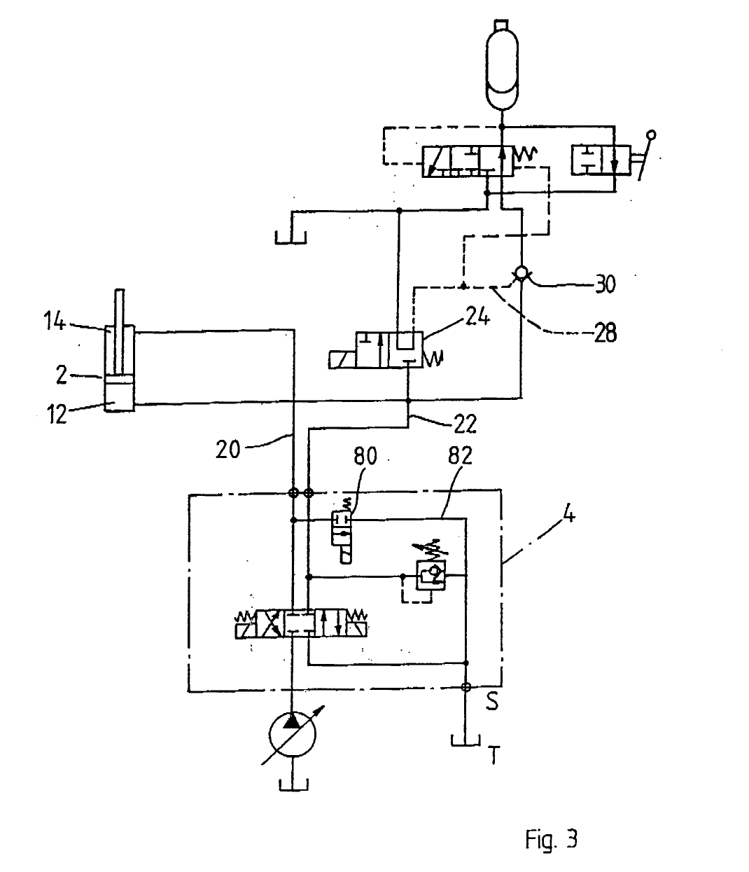

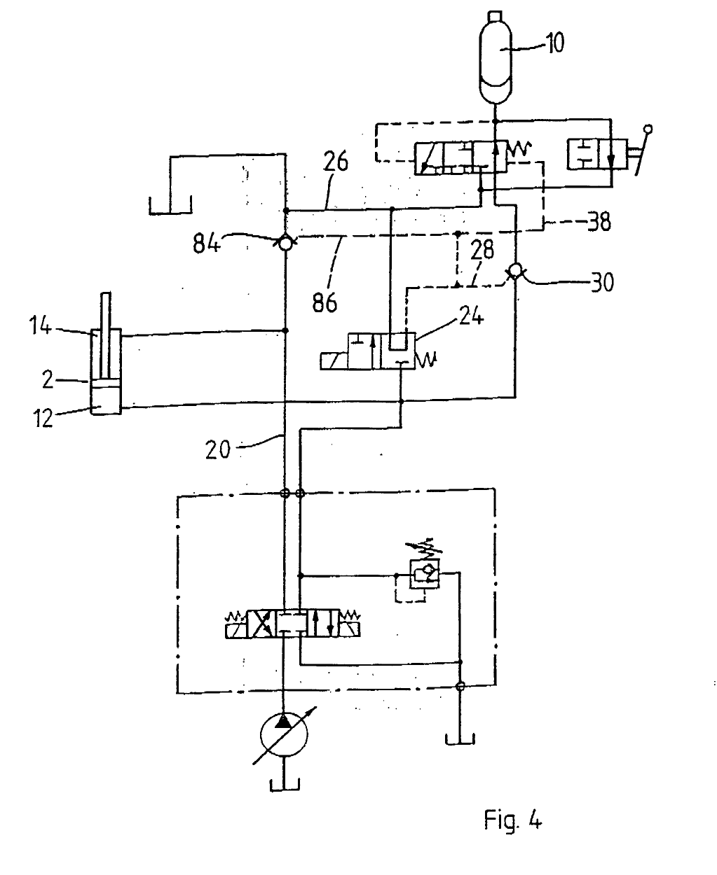

FIGS. 3, 4 are switching diagrams of two further embodiments,

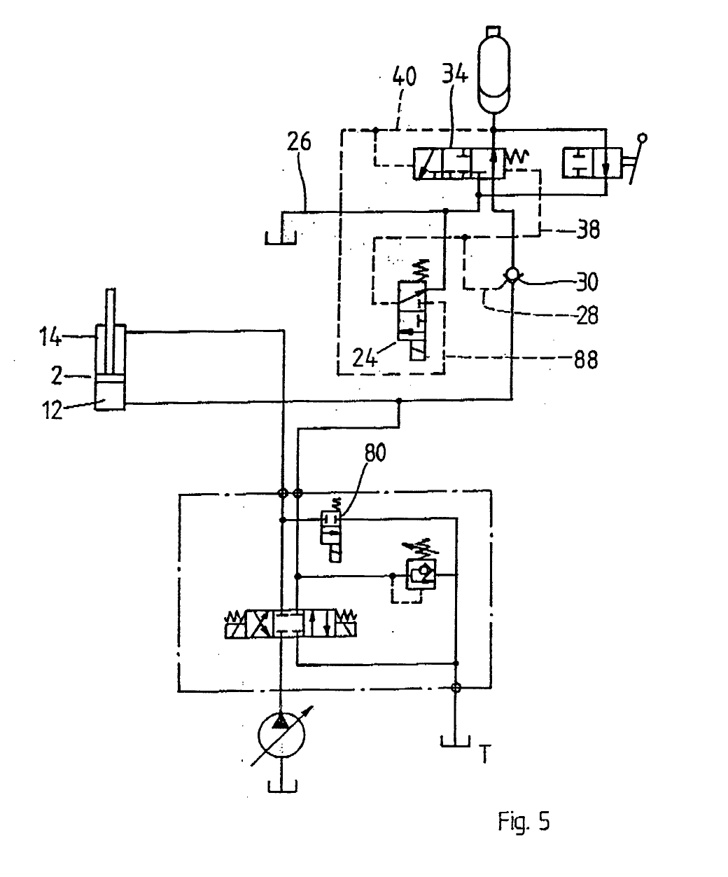

FIG. 5 is a switching diagram of a variant of the embodiment represented in FIG. 3,

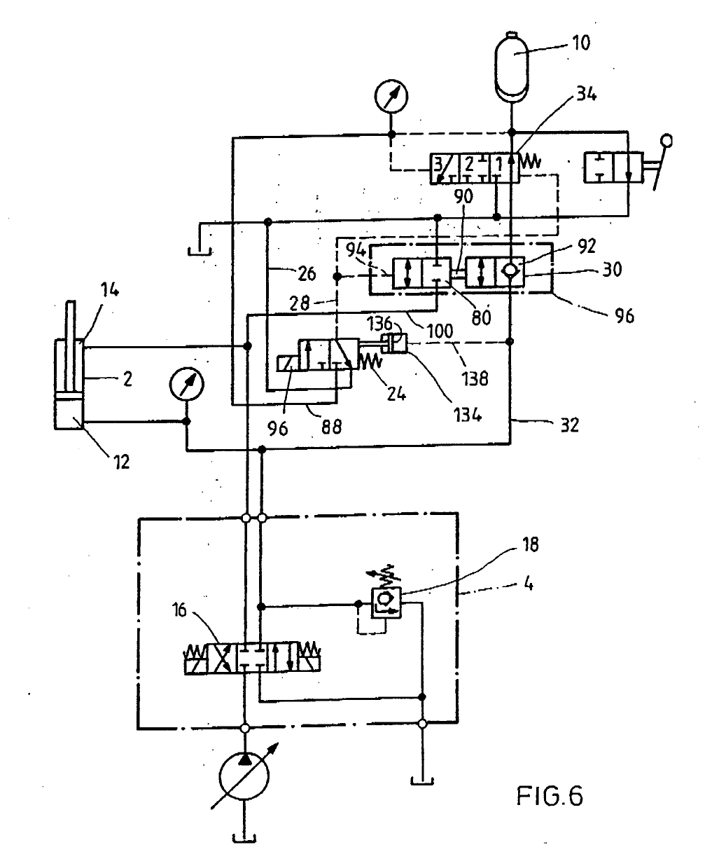

FIG. 6 is a switching diagram of an embodiment which is simplified in comparison with the above described solutions, and

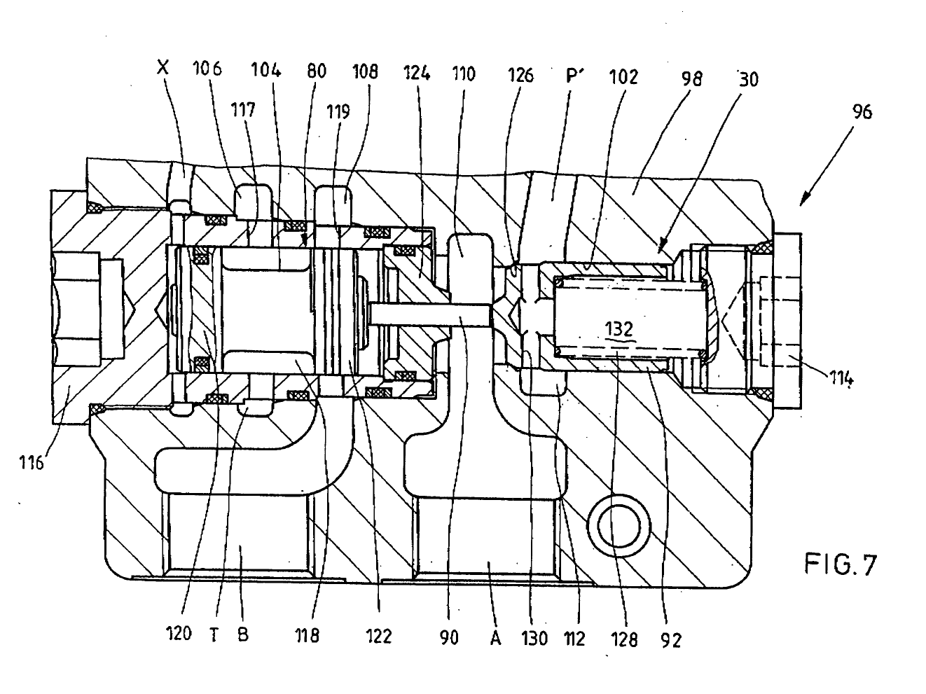

FIG. 7 is a sectional view of a directional control valve as usable in the switching diagrams in accordance with FIGS. 1, 3, 4, 5 and 6.

FIG. 1 represents a strongly simplified switching diagram of a control arrangement for controlling a hydraulic cylinder supporting a boom of a mobile working tool, e.g. of a wheel loader, which hydraulic cylinder shall in the following be referred to as a lift cylinder 2. The latter may be connected to a hydraulic pump 6 or to a tank T via a loader control block 4 represented in dash-dotted line.

The represented control arrangement includes an attenuation valve arrangement 8—equally indicated in dash-dotted line—whereby the vibrations occurring during travel of the wheel loader, for example pitching vibrations, are attenuated. This attenuation valve arrangement 8 is designed such that for the duration of the travel condition, lift cylinder 2 is connected to a hydraulic accumulator 10, so that lift cylinder 2 is subjected to the pressure in hydraulic accumulator 10 in the supporting direction.

In the embodiment represented in FIG. 1, loader control block 4 includes a pressure port P to which hydraulic pump 6 is connected. Two work ports A, B of loader control block 4 may be connected via attenuation valve arrangement 8 to a cylinder chamber 12 or to a rod-side ring chamber 14 of hydraulic cylinder 2, respectively. Tank T is connected to a tank port S.

Loader control block 4 includes an electrically operated control valve 16 designed as a 4/3-directional control valve which blocks the work ports A, B relative to pressure port P and tank port S in its spring-biased home position.

In a first switching position a, pressure port P is connected to work port B and work port A is connected to tank port S in order to extend the hydraulic cylinder 2, so that pressure medium is supplied to cylinder chamber 12 and from ring chamber 14 to tank T. In the other switching position b, work port A is connected to pressure port P and tank port S is connected to work port B in order to retract the hydraulic cylinder 2.

For the purpose of limiting the pressure acting at work port B, loader control block 4 includes a pressure limiting valve 18 through which work port B can be connected to tank port S when a maximum pressure of, e.g., 330 bar is exceeded.

The attenuation valve arrangement 8 has two inlet ports R, U connected with work ports A, B, and two work ports A′ and B′ as well as a tank port T. The two inlet ports R, U are connected to the inlet ports of an electrically operated 4/2-directional control valve 24 via passages 20, 22. With the aid of a compression spring this directional control valve is biased into a home position in which passages 20, 22 are blocked. By energizing an electromagnet, directional control valve 24 may be taken into its second switching position wherein passage 20 is connected with tank passage 26 connected to tank port T, and passage 22 is connected with a control passage 28 indicated in phantom line. The latter leads to the control port of a releasable check valve 30 that is arranged in a pressure passage 32 branching off from passage 22. This pressure passage leads to a pressure port P′ to which the hydraulic accumulator 10 is connected. In the range between pressure port P′ and check valve 30 a control valve 34 having a pressure reducing and pressure limiting function is arranged, which shall be described in more detail hereinafter. The control valve 34 is urged toward its represented home position by a compression spring 36 and the pressure tapped from control passage 28 via a branch passage 38, and into the opposite direction by the pressure acting in hydraulic accumulator 10. This pressure is tapped via a control conduit 40 in the range of pressure port P′ and conveyed to the end face of the valve element acting against compression spring 36.

In order to relieve the hydraulic accumulator 10 of load, a shut-off valve 42 arranged in a bypass line 44 is associated with attenuation valve arrangement 8, whereby pressure port P′ may be connected to tank passage 26 while bypassing control valve 34. In the normal operating condition of the wheel loader, this shut-off valve 42 is closed.

A situation is assumed in which the shovel, which is linked to the boom, rests on the ground when operation of the wheel loader is initiated once the motor is started, control valve 16 is taken into its switching position designated as a, so that cylinder chamber 12 of lift cylinder 2 is supplied with pressure medium by pump 6, while ring chamber 14 is connected with tank T: lift cylinder 2 extends, and the shovel is raised off the ground. The pressure acting in cylinder chamber 12 propagates via pressure passage 32, check valve 30, and control valve 34 located in its home position, as far as hydraulic accumulator 10. The carrying pressure of lift cylinder 2 in the load-free condition—depending on the weight of the shovel—is about 30 to 50 bar. This pressure then is also present in hydraulic accumulator 10.

If this pressure increases on account of the shovel being loaded during working operation, control valve 34 is shifted from its spring-biased home position by the control pressure prevailing in control conduit 40 into a control position having a pressure limiting function, wherein the pressure conveyed to the hydraulic accumulator 10 is reduced to a limit value of, e.g., 120 bar. The control pressure acting in branch passage 38 in the direction toward compression spring 36 is equal to the tank pressure, for directional control valve 24 still is in its represented home position.

Filling hydraulic accumulator 10 beyond the pressure of 120 bar as set in the pressure reducing function is not possible, for control valve 34 then is in the central blocking position.

For the case that the pressure in hydraulic accumulator 10 further increases beyond the above mentioned limit of, e.g., 120 bar due to pressure peaks, control valve 34 may be taken into a pressure limiting position by the pressure in control conduit 40, in which position the hydraulic accumulator 10 is connected with tank passage 26 so that a maximum pressure limitation to 150 bar, for example, is realized.

In this way a decompression shock due to an excessive maximum pressure in hydraulic accumulator 10 upon actuation of control valve 16 is prevented at minimum expenditure.

For the case that the pressure in the hydraulic accumulator 10 drops below 120 bar, check valve 30 prevents relieving of pressure into the hydraulic accumulator 10 via the pressure passage 32.

If the wheel loader is now locomoted to the work site, initially control valve 16 is taken into its neutral center position wherein ports A, B and P, S are blocked relative to each other. In addition, directional control valve 24 is switched, so that ring chamber 14 of lift cylinder 2 is connected with tank port T. Moreover in this switching position of directional control valve 24, control passage 28 is connected to passage 22 wherein the pressure in cylinder chamber 12 prevails. Through suitable adjustment of the transformation ratio of check valve 30, this pressure in control passage 28 is sufficient for releasing check valve 30, so that hydraulic accumulator 10 is connected with cylinder chamber 12 via control valve 34, the opened check valve 30, and pressure passage 32—lift cylinder 2 is held in its supported position by the pressure in accumulator 10. Here control valve 34 is in its represented home position. Due to the fact that hydraulic accumulator 10 is always subjected to pressure when the system is switched on, the boom is reliably prevented from being lowered. As the right-hand end face of the valve element of control valve 34 is subjected to the pressure present in cylinder chamber 12, this control valve is held in its represented home position. As hydraulic accumulator 10 is always subjected to the same pressure when the system is switched on, the shovel is prevented from dropping. The pressure limiting function of control valve 34 is performed in the traveling condition by pressure limiting valve 18, so that the pressure in pressure passage 32 is limited. This pressure limiting valve 18 is provided with an anti-cavitation function.

In the solution according to the invention, the pressure reducing and pressure limiting functions of the control valve 34 are combined in a single valve, the construction of which is described by referring to FIG. 2.

FIG. 2 shows a longitudinal section of a preferred embodiment of control valve 40 of FIG. 1 which is designed as a combined pressure reducing/pressure limiting valve. Control valve 34 has a valve housing 46 through which a valve bore 48 extends. Into this valve bore there open a pressure port P, an accumulator port A, a tank port T indicated in dashed line, as well as a front-end side control port X. In valve bore 48 a valve element 50 is guided which in its home position—not represented—is biased by compression spring 36 against a stop screw 52 that is screwed into the end face portion of valve bore 48 represented on the right in FIG. 2.

The compression spring 36 is arranged in a spring chamber 56 radially expanded in comparison with valve bore 48 and supported on a connecting bush 54, through which control port X extends and which is screwed into housing 46 in the junction area of spring chamber 56 or of valve bore 48, respectively. Compression spring 36 acts on valve element 50 via a spring retainer 57. This valve element has in its center area several pockets 58 distributed on the periphery, by the end faces of which two control lands 60 and 62 are formed.

With the aid of control land 62 the connection between a pressure space 64 opening into pressure port P and an accumulator space 66 opening into accumulator port A may be controlled open and closed with the aid of control land 60 the connection between accumulator apace 66 and a tank space 68 opening into tank port T is controlled open and closed

In the areas of the web remaining between pockets 58, valve element 50 is penetrated by radial bores 70 opening into an axial blind bore 72 wherein a measuring piston 74 is guided. An end portion of measuring piston 74, which protrudes from valve element 50, is supported on the end face of stop screw 52.

Pressure medium may accordingly enter from accumulator space 66 via radial bore 70 into the space defined by measuring piston 74 and by axial blind bore 72, so that valve element 50 is subjected to the pressure acting on end face 76 of axial blind bore 72 against the force of compression spring 36.

In its spring-biased home position, valve element 50 contacts stop screw 52, so that the connection from pressure port P to accumulator port A is controlled open via the control land 62 while the connection with tank port T is blocked. This corresponds to the first switching position of control valve 34 as represented in FIG. 1. The pressure in hydraulic accumulator 10 is reported into spring chamber 56 via control port X, so that the pressure force component resulting from the pressure in spring chamber 56 biases valve element 50 into the closed position in addition to the force of compression spring 36, whereas the resulting pressure force acting on end face 76 acts on valve element 50 in the opposite direction. The space 78 remaining between stop screw 52 and the end face of valve element 50 is connected with tank port T via a connecting bore not represented here.

As can be taken from the comparison with FIG. 1, pressure port P is connected with pressure passage 32; accumulator port A is connected with hydraulic accumulator 10; tank port T is connected with tank passage 26; while branch passage 38 opens into control port X. In the inactive condition of directional control valve 24, this branch passage 38 is connected with tank port T via directional control valve 24, so that the tank pressure is present in spring chamber 56.

In order to raise the shovel, i.e., in order to extend lift cylinder 2, control valve 16 is taken into switching position a in the above described manner. As a result, pressure medium flows via pressure passage 32 to pressure port P and from there across the opened connection between pressure space 64 and accumulator space 66 to hydraulic accumulator 10, so that the latter is extended in correspondence with the pressure at lift cylinder 2. This accumulator pressure also is present in the axial blind bore 72, so that the valve element is acted on by the resulting pressure force component in a direction opposite to the force of compression spring 36. As a result of filling hydraulic accumulator 10 via pressure port P, the accumulator pressure rises, so that due to the pressure acting on the end face 76, valve element 50 is shifted to the left against the force of compression spring 36, so that the connection between pressure space 64 and accumulator space 66 is reduced in size via control land 62—control valve 34 again is in its pressure reducing function. when the preset limit value—for example 120 bar—is reached, the connection between pressure space 64 and accumulator space 66 is closed fully by control land 62—this valve position is represented by the central blocking position of control valve 40 in FIG. 1. In other words, in this condition the connection to lift cylinder 2 or to hydraulic pump 6, respectively, is interrupted, so that hydraulic accumulator 10 cannot be charged any further. In the pressure reducing or blocking function of control valve 34, the connection between accumulator space 66 and tank space 68 remains closed.

If a pressure peak propagating as far as hydraulic accumulator 10 is now generated in the system, for example brought about by other consumers, then the valve element is taken by the increased accumulator pressure beyond the above described position to the left into the position represented in FIG. 2 wherein the connection between accumulator space 66 and tank space 68 is controlled open via control land 60—the valve now is in its pressure limiting function whereby the maximum pressure of the hydraulic accumulator may be limited to a preset limit value, e.g. 150 bar. Such excessive accumulator pressures may also occur as a result of leakage or temperature increase.

In travel operation the directional control valve 24 is switched, so that a control pressure corresponding to the pressure in cylinder chamber 12 is conveyed to control port X via control passage 28 and branch passage 38. I.e., in travel operation the valve element is moved back by this control pressure and by the force of the compression spring 36 against the resulting pressure force acting on the end face 76 into its home position wherein the pressure space 64 is connected to accumulator space 66 via control land 62, whereas the connection with tank space 68 via control land 60 is blocked.

Control valve 34 may also be used in the variants of the inventive system described hereinbelow.

In the embodiment represented by FIG. 1, directional control valve 24 is designed as a 4/2-directional control valve, wherein ring chamber 14 of lift cylinder 2 is connected with tank passage 26 via directional control valve 24 in the traveling condition. FIG. 3 shows a variant of the control arrangement according to the invention, where the directional control valve 24 is designed as a 3/2-directional control valve. In its spring-biased home position, this directional control valve 24 blocks passage 22 connected with cylinder chamber 12 relative to tank passage 26 and control passage 28. In travel operation, directional control valve 24 is switched so that passage 22 is connected with control passage 28, and check valve 30 is released. In this switching position of directional control valve 24, tank passage 26 is blocked.

Other than in the above described embodiment, ring chamber 14 of lift cylinder 2 is connected to tank T via a actuator valve 80 of loader control block 4. This actuator valve 80 is arranged in a tank line 82 connecting passage 20 with tank port S. In the spring-biased home position of actuator valve 80 designed as an electrically operated 2/2-directional control valve, tank line 82 is blocked. In travel operation, actuator valve 80 is switched to the through position with the aid of a switching magnet, so that the connection between ring chamber 14 and tank T is opened.

For the rest, the variant represented in FIG. 3 corresponds to the embodiment explained by referring to FIG. 1, so that reference is made to the explanations given there for the sake of simplicity.

FIG. 4 shows another simplified embodiment wherein—similar to FIG. 3—directional control valve 24 is designed as a 3/2-directional control valve through which control passage 28 is connected with tank passage 26 in the spring-biased home position. In the embodiment represented in FIG. 4, passage 20 leading to ring chamber 14 is connected to the tank passage via another releasable check valve 84. For releasing this further check valve 84, the pressure at the outlet of directional control valve 24, i.e., the pressure in control passage 28, may be tapped via a control conduit 86. Accordingly, the two check valves 30 and 84 are released by switching over directional control valve 24 with the aid of the pressure in cylinder chamber 12 of lift cylinder 2. As a result, on the one hand hydraulic accumulator 10 is connected with cylinder chamber 12, and on the other hand ring chamber 14 of the lift cylinder is connected with tank passage 26 via passage 20 and check valve 84. The further check valve 84 allows pressure medium being sucked into ring chamber 14 for replenishing.

For the rest, the embodiment represented in FIG. 4 corresponds to the one of FIG. 1, so that further explanations may be omitted.

In the above described embodiments, the pressure present in cylinder chamber 12 of lift cylinder 2 was switched through in order to release check valve(s) 30 (84) and in order to urge valve element 50 of control valve 34 in the direction toward compression spring 36. Under certain operating conditions, this pressure may be substantially lower than the pressure in hydraulic accumulator 10 to which the latter was charged during the work cycle. In order to ensure check valves 30 (84) being released and the work tool being secured even at a lower pressure in cylinder chamber 12, however, control valve 34 and releasable check valves 30, 84 have to be designed with high pressure transformation ratios, whereby the construction size in particular of releasable check valves 30 and 84 is greatly increased.

In FIG. 5 a variant is proposed wherein the pressure transformation ratio may be adjusted to be substantially lower than in the above described embodiments. The basic principle of the circuit explained in FIG. 5 corresponds to the embodiment explained with the aid of FIG. 3—in principle, however, the variant in accordance with FIG. 5 may also be transferred to the embodiments in accordance with FIGS. 1 and 4.

Similar to the embodiment represented in FIG. 3, in travel operation ring chamber 14 of lift cylinder 2 is connected with tank T via a actuator valve 80 in the arrangement in accordance with FIG. 5. Releasing check valve 30 is effected with the aid of electrically operated directional control valve 24, which in the embodiment represented in FIG. 5 also has the form of a 3/2-directional control valve.

In its spring-biased home position, directional control valve 24 connects control passage 28 as well as branch passage 38 with tank passage 26. Upon actuation of directional control valve 24, the connection with tank passage 26 is closed and control passage 28 as well as branch passage 38 are connected with an accumulator line 88 which opens into control conduit 40. In other words, upon switching directional control valve 24 the pressure in hydraulic accumulator 10 is switched through into control passage 28 via control conduit 40 and accumulator line 88, so that check valve 30 is released by the higher pressure of the hydraulic accumulator.

In the embodiment represented in FIG. 5, check valve 30 is thus released by the same pressure that acts on the end face of valve element 50 of control valve 34 acting against compression spring 36. As a result of the higher control pressure, the pressure transformation ratio of check valve 30 may be designed to be substantially smaller.

In the above described embodiments, in the travel operation ring chamber 14 of hydraulic cylinder 2 is connected to the tank either via directional control valve 24 or via actuator valve 80, or via the further releasable check valve 84. Release of check valve 30 is in all of the above described embodiments effected with the aid of a control pressure which is tapped via directional control valve 24 from hydraulic accumulator 10 or from cylinder chamber 12 of hydraulic cylinder 2. This control pressure acts on a topping piston whereby check valve 30 may be taken into its open position.

FIG. 6 shows a switching diagram of a simplified embodiment where this topping piston of check valve 30 may be omitted. The basic structure of the embodiment represented in FIG. 6 corresponds in its basic principle to the switching diagram of the embodiments explained by referring to FIGS. 3 and 5.

In the embodiment represented in FIG. 6, directional control valve 24 is in turn designed as a 3/2-directional control valve, wherein control passage 28 is connected in the inoperative position of directional control valve 24 with tank passage 26 and in the switching position—i.e. in the travel operation—with accumulator passage 88 actuator valve 80, which in this case is operated hydraulically, is not arranged in the loader control block 4 as in the embodiments represented in FIGS. 3 and 5, but is part of the attenuation means.

In the represented embodiment, actuator valve 80 having the form of a 2/2-switching valve is connected with valve body 92 of releasable check valve 30 via a plunger 90, so that the switching movement of actuator valve 80 is transmitted to check valve 30 so as to take the latter into its open position. Through this mechanical coupling between actuator valve 80 and check valve 30, the topping piston that is necessary in the above described embodiments may be omitted.

In the represented home position, actuator valve 80 is in its blocking position whereby the connection between tank passage 26 and ring chamber 14 of lift cylinder 2 is blocked. The end face of the piston of actuator valve 80 that acts in the opening direction is subjected to the pressure in control passage 28 via a control conduit 94, so that the tank pressure is present at this control surface in the inoperative position of directional control valve 24.

When the electromagnet 96 of directional control valve 24 is energized, the latter is taken into its switching position wherein control passage 28 is connected with accumulator line 88, so that control valve 34 is taken into its home position designated by 1. In accordance with the variant represented in FIG. 3, this control pressure may, however, also be tapped at cylinder chamber 12 of lift cylinder 2.

The control pressure corresponding to the pressure in hydraulic accumulator 10 or in cylinder chamber 12 also acts via control conduit 94 on control surface acting in the opening direction of piston actuator valve 80, so that the latter is taken into its open position in which ring chamber 14 of lift cylinder 2 is connected with tank passage 26. The switching movement of actuator valve 80 is transferred via plunger 90 to valve body 92 of check valve 30, so that the latter is taken into its open position in which lift cylinder 2 is supported by the pressure in hydraulic accumulator 10.

FIG. 7 shows a sectional view of a valve assembly 96 having the actuator valve 80 and the check valve 30 integrated therein.

The represented valve assembly 96 is accommodated in a valve plate 98 in which two work ports A, B, tank port T opening vertically to the plane of drawing, and an accumulator port P′ are formed. Work port A is connected to cylinder chamber 12 via pressure passage 32, and work port B is connected to ring chamber 14 of lift cylinder 2 via a working passage 100 (cf. FIG. 6). Hydraulic accumulator 10 is connected to the accumulator port P′.

Through the valve plate 96 there extends in the transverse direction (FIG. 7) a valve bore 102 in which the valve body 92 of the check valve 30 and a piston 104 of the actuator valve 80 are received.

In the reception bore 102 ring chambers 106, 108, 110 and 112 are formed which are connected with tank port T, work port B, work port A and accumulator port P′, respectively. Reception bore 102 is blocked on its front end side by a screw plug 114 and a guide bush 116 closed on one side wherein piston 104 is guided. This guide bush 116 has a multiplicity of jacket recesses 117, 119 opening into the range of ring chambers 106, 108, so that the pressure medium may enter into inner space 118 of guide bush 116.

On the end face side of piston 104, two radially protruding ring collars 120, 122 are formed so as to slidingly contact the peripheral wall of inner space 118. The partial space of inner space 118 adjacent the end face of ring collar 122 is connected with tank port T and thus not pressurized. In the right-hand end face in FIG. 7 guide bush 116 is sealingly inserted into a bush 124 wherein plunger 90 is slidingly guided.

The one end portion of this plunger 90 plunges into inner space 118 of guide bush 116 and contacts the adjacent end face of piston 104. The other end portion of plunger 90 protrudes into ring chamber 110 and is placed in contact with, or at a small distance from valve body 92 of check valve 30 that is mounted in the right-hand end portion of reception bore 102. In this range reception bore 102 has a valve seat 126 against which a conical end portion of valve body 92 having the form of a hollow piston is biased with the aid of a closure spring 128. This closure spring 128 supports itself on closure spring 114 and attacks at an internal annular end face of valve body 92.

In the range of the conical end portion, valve body 92 is provided with a multiplicity of jacket bores 130. Via these jacket bores 130 a spring chamber 132 for closure spring 128 is connected with accumulator port P′, so that the check valve is subjected to the force of closure spring 128 and the pressure in hydraulic accumulator 10 in the closing direction. In the opening direction the pressure in ring chamber 110, corresponding to the pressure in cylinder chamber 12, acts on valve body 92.

In the home position, valve body 92 rests on valve seat 126, so that the connection between cylinder chamber 12 and hydraulic accumulator 10 is blocked. Piston 104 is urged by plunger 90 into its left-hand end position wherein ring collar 122 closes jacket opening 119 while jacket opening 117 is open, so that the ring chamber between the two ring collars 120 and 122 is subjected to tank pressure.

A control port X connected via control conduit 94 to control passage 28 and thus to the outlet port of directional control valve 24 opens into the pressure space adjacent the left-hand end face of piston 104. In the inoperative position of directional control valve 24, the tank pressure then acts on this control port X.

When the directional control valve 24 is switched with the aid of electromagnet 96, the pressure at hydraulic accumulator 10 (embodiment in accordance with FIG. 6) or the pressure in cylinder chamber 12 (embodiment in accordance with FIG. 3) is present at control port X. As piston 104 has a larger end face than the end face of valve body 92 acting in the opposite direction, piston 104 in the representation according to FIG. 7 is moved to the right by the control pressure acting on its left end face, so that ring collar 122 controls jacket opening 119 open and thereby opens the connection from work port B communicating with ring chamber 108 to tank port T. The axial displacement of piston 104 is transferred via plunger 90 to valve body 92, so that the latter is raised from its valve seat 126, and the connection from hydraulic accumulator 10 to cylinder chamber 12 is controlled open—lift cylinder 2 thus is supported by the pressure in hydraulic accumulator 10.

FIG. 6 shows another optional development of the attenuation valve means. Accordingly it is possible to associate a deactivating means 134 to the directional control valve 24. In the represented embodiment, this deactivating means 134 is realized with the aid of a deactivating piston 136 acting in the same direction as the compression spring of directional control valve 24 auf the valve member thereof. The rear side of deactivating piston 136 is subjected to the pressure in pressure passage 32 via an actuating passage 138. The effective end face of deactivating piston 136 is designed such that directional control valve 24 may be returned into its inoperative position in the event of pressure peaks, even against the force of energized electromagnet 96, so that the attenuation means is turned off and damage to hydraulic accumulator 10 is prevented. This deactivating means may, of course, equally be provided in the embodiments in accordance with FIGS. 1-5. Instead of the mechanical deactivating means an electric pressure deactivation may also be provided, whereby directional control valve 24 is returned into its inoperative position when a maximum pressure in pressure passage 32 or at hydraulic accumulator 10 is exceeded.

What is disclosed is a hydraulic control arrangement for attenuating travel vibrations of a mobile working tool, comprising a lift cylinder supporting a working tool, the cylinder chambers of which may be connected to a pressure medium source or to a tank via a control valve arrangement. The hydraulic control arrangement moreover includes an attenuation valve arrangement for connection of one cylinder chamber with an hydraulic accumulator and of the other cylinder chambers with a tank. In accordance with the invention, the attenuation valve arrangement includes a valve having a pressure limiting function and arranged between a check valve and the hydraulic accumulator, so that the pressure in the hydraulic accumulator may reliably be limited to a maximum value.

List of Reference Symbols

| | |
|---|---|
| 2 | lift cylinder |
| 4 | loader control block |
| 6 | pump |
| 8 | attenuation valve arrangement |
| 10 | hydraulic accumulator |
| 12 | cylinder chamber |
| 14 | ring chamber |
| 16 | control valve |
| 18 | pressure limiting valve |
| 20 | passages |
| 22 | passages |
| 24 | directional control valve |
| 26 | tank passage |
| 28 | control passage |
| 30 | check valve |
| 32 | pressure passage |
| 34 | control valve |
| 36 | compression spring |
| 38 | branch passage |
| 40 | control conduit |
| 42 | shut-off valve |
| 44 | bypass line |
| 46 | valve housing |
| 48 | valve bore |
| 50 | valve element |
| 52 | stop screw |
| 54 | connecting bush |
| 56 | spring chamber |
| 57 | spring retainer |
| 58 | pockets |
| 60 | control land |
| 62 | control land |
| 64 | pressure space |
| 66 | accumulator space |
| 68 | tank space |
| 70 | radial bore |
| 72 | axial blind bore |
| 74 | measuring piston |
| 76 | end face |
| 78 | space |
| 80 | float position valve |
| 82 | tank line |
| 84 | check valve |
| 86 | control conduit |
| 88 | accumulator line |
| 90 | plunger |
| 92 | valve body |
| 94 | control conduit |
| 96 | valve assembly |
| 98 | valve plate |
| 100 | working passage |
| 102 | reception bore |
| 104 | piston |
| 106 | ring chamber |
| 108 | ring chamber |
| 110 | ring chamber |
| 112 | ring chamber |
| 114 | screw plug |
| 116 | guide bush |
| 118 | inner space |
| 120 | ring collar |
| 122 | ring collar |
| 124 | bush |
| 126 | seat |
| 128 | closure spring |
| 130 | jacket bore |
| 132 | spring chamber |
| 134 | deactivating means |
| 136 | deactivating piston |

1. Hydraulic control arrangement for at vibrations of a mobile working tool a hydraulic cylinder supporting a work tool, the cylinder chambers of which may be connected to a pressure medium source or to a tank via a control valve arrangement, and an attenuation valve arrangement for connection of one cylinder chamber with an hydraulic accumulator and of the other cylinder chambers to said tank, wherein said attenuation valve arrangement includes a valve for influencing the pressure in said hydraulic accumulator and a check valve for preventing a return flow of pressure medium from said hydraulic accumulator to said cylinder chamber, characterized in that said check valve is arranged between said one cylinder chamber and said valve, the latter having a pressure limiting function whereby pressure medium may be discharged from said hydraulic accumulator to said tank when a limit pressure is exceeded.

2. Hydraulic control arrangement according to claim 1, wherein said check valve is designed to be releasable and the control pressure for releasing is tapped at said one cylinder chamber or at said hydraulic accumulator.

3. Hydraulic control arrangement according to claim 2, wherein said attenuation valve arrangement includes a directional control valve, preferably being actuated electromagnetically, through which in one switching position said other cylinder chamber is connected to said tank and/or a control port of said check valve is connected to said one cylinder chamber or to said hydraulic accumulator.

4. Hydraulic control arrangement according to one of claims 1 to 3, including an actuator valve whereby said other cylinder chamber may be connected to said tank.

5. Hydraulic control arrangement according to claim 1, including another releasable check valve, the control port of which is acted on by essentially the same pressure as said check valve and through which a connection between said other cylinder chamber and said tank may be controlled open.

6. Hydraulic control arrangement according to claim 4, wherein said check valve may be taken into its open position via said actuator valve.

7. Hydraulic control arrangement according to claim 6, wherein a piston of said actuator valve acts as a topping piston for said check valve.

8. Hydraulic control arrangement according to claim 3, wherein deactivating means are associated to said directional control valve whereby the latter may be taken into its spring-biased inoperative position.

9. Hydraulic control arrangement according to claim 8, wherein said deactivating means include a deactivating piston acting on the valve member of said directional control valve, which deactivating piston is subjected to the pressure in said one cylinder chamber.

10. Hydraulic control arrangement according to claim 1, wherein said valve includes a valve element which may be subjected to the pressure in said hydraulic accumulator on the one hand and a compression spring and the pressure in said one cylinder chamber of said hydraulic cylinder, or the pressure in said hydraulic accumulator on the other hand, and whereby a connection of an accumulator port connected with the hydraulic accumulator with a pressure port or or a tank port may be controlled open depending on the accumulator pressure.

11. Hydraulic control arrangement according to claim 10, wherein in one end portion of said valve element of said valve a measuring piston supported on the housing is guided, and the space defined by said measuring piston and said valve element is subjected to the pressure in said hydraulic accumulator.

12. Hydraulic control arrangement according to claim 1, wherein said control valve arrangement has an adjustable pressure limiting valve whereby the pressure in said one cylinder chamber may be limited.

13. Hydraulic control arrangement according to claim 12, wherein said pressure limiting valve is designed with an anti-cavitation function.

14. Hydraulic control arrangement according to claim 3, wherein the outlet port of said directional control valve connected with the control port of said check valve is connected with a spring chamber of said valve via a control passage.

15. Hydraulic control arrangement according to claim 1, including a bypass line bypassing said valve and having arranged therein a shut-off valve, and whereby said hydraulic accumulator may be connected to said tank.
